(19) United States
(12) Patent Application Publication
(10) Pub. No.: US 2026/0154583 A1
(43) Pub. Date: Jun. 4, 2026

(54) Error-Correcting Codes for Fermionic Quantum Simulation

(71) Applicant: Government of the United States of America, as represented by the Secretary of Commerce, Gaithersburg, MD (US)

(72) Inventors: Alexey Vyacheslavovich GORSHKOV, Potomac, MD (US); Yu-An CHEN, Greenbelt, MD (US); Yijia XU, Greenbelt, MD (US)

(21) Appl. No.: 18/913,257

(22) Filed: Oct. 11, 2024

Related U.S. Application Data
(60) Provisional application No. 63/589,409, filed on Oct. 11, 2023.

(51) Int. Cl. G06N 10/20; G06N 10/70

(52) U.S. Cl. CPC G06N 10/20; G06N 10/70

(57) ABSTRACT

A method of encoding fermions into lattices of qubits for quantum simulation of a fermionic system includes choosing a desired distance d of a code; preparing within the code Hilbert space by measuring stabilizers Gᵥ for each vertex, v, of a 2D lattice and making corrections necessary to ensure that, after rotations are applied, Gᵥ=1 for each v; preparing a desired initial state of the encoded fermions; and converting a Hamiltonian of the fermionic system into a qubit Hamiltonian and then running an evolution of the fermionic system.

### RELATED APPLICATIONS

This application claims the benefit of U.S. Provisional Patent Application Ser. No. 63/589,409 (filed Oct. 11, 2023), which is herein incorporated by reference in its entirety.

### FEDERALLY-SPONSORED RESEARCH AND DEVELOPMENT

This invention was made with United States Government support from the National Institute of Standards and Technology (NIST), an agency of the United States Department of Commerce. The Government has certain rights in this invention.

### COPYRIGHT NOTICE

This patent disclosure may contain material that is subject to copyright protection. The copyright owner has no objection to the facsimile reproduction by anyone of the patent document or the patent disclosure as it appears in the U.S. Patent and Trademark Office patent file or records, but otherwise reserves any and all copyright rights.

### FIELD OF INVENTION

The present invention relates generally to quantum systems and devices, and more particularly to systems, methods, and devices for providing fermions by qubits on 2-D lattices using the framework of Z₂ lattice gauge theories.

### BACKGROUND

Error-correcting codes were initially developed to correct quantum errors on noisy quantum devices and have found further applications in condensed matter physics and high-energy physics. A cornerstone of quantum error correction is the stabilizer formalism, which defines the codewords as the common eigenspace of elements in an Abelian group, referred to as the stabilizer group. A stabilizer code is labeled [[n, k, d]] when it uses n physical qubits to encode k logical qubits with code distance d. The code distance is the minimum weight of an operator that commutes with all elements in the stabilizer group but is not in the stabilizer group itself. The ratios k/n and d/n determine the quality of codes.

### SUMMARY OF INVENTION

The ability to efficiently and robustly simulate quantum systems of interacting fermions would revolutionize quantum chemistry and quantum materials science. The main obstacle to the precise quantum simulation of large systems of interacting fermions is errors in a quantum computer. Disclosed herein are new approaches to simulate fermions by qubits on two-dimensional lattices in a way that makes the simulation more robust to errors. In particular, we propose a systematic way to increase the code distances d of so-called stabilizer error correcting codes. Increasing the code distance is important because a code with distance d can correct any [(d−1)/2]-qubit error. We identify a family of stabilizer codes that can be used to simulate fermions with code distances of d=2, 3, 4, 5, 6, 7. The syndromes for all Pauli errors are provided.

According to one aspect of the invention, a method of encoding fermions into lattices of qubits for quantum simulation of a fermionic system includes the steps of choosing a desired distance d of a code; preparing within the code Hilbert space by measuring stabilizers Gᵥ for each vertex, v, of a 2D lattice and making corrections necessary to ensure that, after rotations are applied, Gᵥ=1 for each v; preparing a desired initial state of the encoded fermions; and converting a Hamiltonian of the fermionic system into a qubit Hamiltonian and then running an evolution of the fermionic system.

Optionally, the step of preparing a desired initial state includes measuring W_{f} for each face f and making corrections tending to move a state of the face towards the desired initial state.

Optionally, running an evolution of the fermionic system includes using analog quantum simulation.

Optionally, running an evolution of the fermionic system includes using digital quantum simulation.

Optionally, the desired distance code d is 3, and the step of preparing within the code includes restricting the Hilbert space using Eq. (12), below.

Optionally, the desired distance code d is 3, and converting a Hamiltonian of the fermionic system into a qubit Hamiltonian is governed by the dictionary in Eq. (11), below.

Optionally, the desired distance code d is 4, and the step of preparing within the code includes restricting the Hilbert space using Eq. (16), below.

Optionally, the desired distance code d is 4, and converting a Hamiltonian of the fermionic system into a qubit Hamiltonian is governed by the dictionary in Eq (15), below.

Optionally, the desired distance code d is 5, and the step of preparing within the code includes restricting the Hilbert space using Eq. (21), below.

Optionally, the desired distance code d is 5, and converting a Hamiltonian of the fermionic system into a qubit Hamiltonian is governed by the dictionary in Eqs. (18, 19, 20), below.

Optionally, the desired distance code d is 6, and the step of preparing within the code includes restricting the Hilbert space using Eq. (87), below.

Optionally, the desired distance code d is 6, and converting a Hamiltonian of the fermionic system into a qubit Hamiltonian is done via the dictionary in Eqs. (84, 85, 86), below.

Optionally, the desired distance code d is 7, and the step of preparing within the code includes restricting the Hilbert space using Eq. (91), below.

Optionally, the desired distance code d is 7, and converting a Hamiltonian of the fermionic system into a qubit Hamiltonian is done via the dictionary in Eqs. (89,90).

Optionally, the method includes the step of measuring desired observables after the evolution is run.

The foregoing and other features of the invention are hereinafter described in greater detail with reference to the accompanying drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows bosonization on a square lattice. Pauli matrices Xₑ, Yₑ, and Zₑ are placed on each edge and one complex fermion c_{f},

$${c}_{f}^{†}$$

on each face. This disclosure uses the Majorana basis

$${γ}_{f} = {c}_{f} + {c}_{f}^{†} and {γ}_{f}^{′} = - i ( {c}_{f} - {c}_{f}^{†} )$$

for convenience.

FIG. 2 shows syndromes of single-qubit errors for the exemplary bosonization with code distance d=3. The red vertices v represent locations where the single-qubit error does not commute with the stabilizer Gᵥ.

FIG. 3 shows syndromes of single-qubit errors for the exemplary bosonization with code distance d=4. The red vertices v represent locations where the single-qubit error does not commute with the stabilizer

$${G}_{v}^{d = 4} .$$

FIG. 4 shows syndromes of single-qubit errors for the exemplary d=5 bosonization.

FIG. 5 shows examples of polynomial expressions for Pauli strings. The flux term (i.e., fermionic occupation) on a plaquette and the hopping term on an edge are both shown. The factors such as x²y² and x² represent the locations of the operators relative to the origin.

FIG. 6 shows circuit representations of sixteen elementary automorphisms. Red lines represent the CZ gates, green lines represent the H^{⊗2}(CZ)H^{⊗2} gates, and blue lines represent the CNOT gates.

FIG. 7 shows a Clifford circuit corresponding to automorphism A₁.

FIG. 8 shows a block diagram of an exemplary method for searching for automorphisms with large code distances.

FIG. 9 shows a block diagram of an exemplary syndrome matching method to find the code distance for a given stabilizer code.

FIG. 10 shows a block diagram of an exemplary method of encoding fermions into lattices of qubits for quantum simulation of fermionic systems in a way that automatically helps with error correction while not unduly increasing the cost of a simulation.

### DETAILED DESCRIPTION

In this work, we propose techniques to simulate fermions by qubits on 2-dimensional lattices using Z₂ gauge theories, i.e., stabilizer codes, showing error-correcting properties for Pauli errors on a quantum computer. Using the symplectic automorphism on Pauli module over the Laurent polynomial ring, we identify a family of error-correcting codes for fermionic simulation. In contrast to the standard code concatenation approach, our method can increase the code distances (which determines the number of errors the code can correct) while maintaining a constant code rate (meaning that the number of encoded logical qubits is proportional to the number of physical qubits). In this way, we construct error-correcting codes with code distances from 3 to 7. Conventional methods have primarily focused on a limited number of instances regarding error-correcting codes for fermionic simulations, often accompanied by various drawbacks. For example, one conventional method considers a distance-3 code capable of correcting single-qubit errors, specifically Majorana loop stabilizer codes; however, the construction is intricate and challenging to generalize. In another conventional method, efforts are made to achieve larger code distances, but this method leads to decreased code rates and results in substantial overhead. Our proposed method offers a systematic approach to increasing code distances while maintaining a constant code rate, with the only trade-off being the increased weights of stabilizers.

Recent developments show the existence of “good” quantum low-density parity-check (LDPC) codes, i.e., with the number of logical qubits k and the code distance d both scaling linearly with the number of physical qubits n. In this paper, our focus is on a different objective. Instead of encoding logical qubits, we aim to encode logical fermions using physical qubits. This motivation comes from the need to simulate fermions on quantum computers since most models of matter involve electrons, which are, in fact, fermions. While fault-tolerant quantum computation is the ultimate goal, current devices still have limited resources and suffer from noise, so error-mitigation schemes are crucial. Therefore, we seek an effective design such that when we implement fermions with qubits on a quantum computer, certain physical qubit errors can be corrected directly in this protocol without having to encode the underlying qubits further. Thus, we want to systematically increase the code distance d in a fermion-to-qubit mapping with a fixed code rate (between logical fermions and physical qubits).

When a fermionic Hamiltonian consists of geometrically local terms, they can be mapped to local qubit operators by the Bravyi-Kitaev superfast encoding and its variants, by the auxiliary methods, or by exact bosonization. There are also proposals that utilize defects of surface codes for fermionic quantum simulation, and those defects have been recently implemented by Google Quantum AI. Variants of these mappings have been studied to optimize different costs. In the context of quantum many-body physics, these mappings also reveal the deep connections between fermion and spin systems. There is another exact fermion-flux lattice duality derived from the Z₂ gauge theory. Aside from the investigation of constructing new mappings, fermion-to-qubit mappings have been studied in the context of variational quantum circuits. In all the above-mentioned methods, extra qubits are required, e.g., the number of qubits is twice the number of fermions on a 2d square lattice. This is the price for the locality-preserving property. These methods can be thought of as stabilizer codes. Given N fermions with the Hilbert space dimension 2^{N}, they are mapped to 2N qubits with space dimension 2^{2N}, which is an enlarged space. After N gauge constraints (stabilizer conditions) are imposed, the gauge-invariant subspace (code space) has dimension 2^{N}, which matches the dimension of the logical fermions. It has been shown that gauge constraints can be utilized for error correction, and code distances can be studied for these stabilizer codes. Prior work demonstrates that an improved Bravyi-Kitaev superfast encoding can correct any single-qubit error in a graph where each vertex has degree d≥6. Another version of the Bravyi-Kitaev superfast encoding has been proposed, called the “Majorana loop stabilizer code,” which is designed to have code distance d=3 such that any single-qubit error can be corrected. However, it is not known how to generalize the Bravyi-Kitaev superfast encoding to produce codes with higher and higher code distances. An alternative approach is code concatenation, where logical qubits in error-correcting codes replace physical qubits in the fermion-to-qubit mappings. However, code concatenation will decrease the code rate between logical fermions and physical qubits, increasing the overhead of fermionic simulation. Presented herein are exemplary methods that increase the code distances of the fermion-to-qubit mappings while preserving the code rate.

In this disclosure, we conjugate an existing stabilizer code with a Clifford circuit. This produces a new stabilizer code. Since the new code is obtained via conjugation by a unitary operator, the algebra of the logical operators is preserved. If we choose the circuit wisely, the new stabilizer code will have a larger code distance (d≥3), compared to the code distance d=2 of the original exact bosonization. To study Clifford circuits systematically, we utilize the Laurent polynomial method. Any Pauli operator can be written as a vector in a symplectic space. For a system with translational symmetry, e.g., the 2d square lattice, the space of Pauli operators becomes a module over a polynomial ring. Furthermore, this polynomial method can be used to formulate the 2d bosonization concisely. The commutation relations of Pauli operators are determined by the symplectic form. There is a one-to-one correspondence (up to a translation operator on the lattice):
Automorphism of the symplectic form⇔Clifford circuit on a 2d square lattice.
   Therefore, the problem of finding new codes turns into a problem of searching for “good” automorphisms of the Pauli module with the symplectic form, which can be achieved efficiently by exhaustive numerical search.

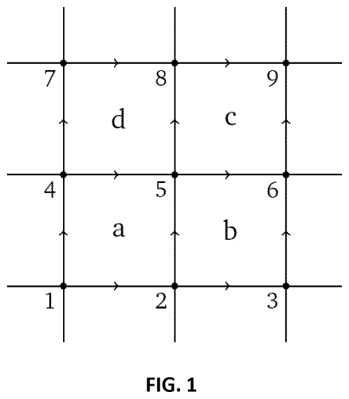

We first describe the Hilbert space in FIG. 1. The elements associated with vertices, edges, and faces will be denoted by v, e, and f, respectively. On each face f of the lattice, we place a single pair of fermionic creation-annihilation operators c_{f},

$${c}_{f}^{†} ,$$

or equivalently a pair of Majorana fermions γ_{f}, γ′_{f}. The even fermionic algebra consists of local observables with trivial fermionic parity, i.e., local observables that commute with the total fermion parity

$${( - 1 )}^{F} ≡ {\prod }_{f} {( - 1 )}^{{c}_{f}^{†} {c}_{f}}$$

where

$$F = {\sum }_{f} {c}_{f}^{†} {c}_{f}$$

is the total fermion number. The even algebra is generated by:
1. On-site fermion parity (occupation):

$${P}_{f} ≡ - i {γ}_{f} {γ}_{f}^{′} . \qquad ( 1 )$$

2. Fermionic hopping term:

$${S}_{e} ≡ - i {γ}_{L} {γ}_{R ( e )}^{′} , \qquad ( 2 )$$

where L(e) and R(e) are faces to the left and right of e, with respect to the orientation of e in FIG. 1.

The bosonic dual of this system involves Z₂-valued spins on the edges of the square lattice. For every edge e, we define a unitary operator Uₑ that squares to 1. Labeling the faces and vertices as in FIG. 1, we define:

$${U}_{56} = {X}_{56} {Z}_{25} , \qquad ( 3 )$$

$${U}_{58} = {X}_{58} {Z}_{45} ,$$

where Xₑ, Zₑ are Pauli matrices acting on a spin at edge e:

$${X}_{e} = [ \begin{matrix}0 & 1 \\ 1 & 0\end{matrix} ] , {Z}_{e} = [ \begin{matrix}1 & 0 \\ 0 & - 1\end{matrix} ] . \qquad ( 4 )$$

Operators Uₑ for the other edges are defined by using translation symmetry. Pictorially, operator Uₑ is depicted as

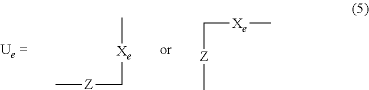

corresponding to the vertical or horizontal edge e.

Uₑ and Sₑ are known to satisfy the same commutation relations. We also map the fermion parity P_{f} at each face f to the “flux operator” W_{f}≡Π_{e⊂f}Zₑ, the product of Zₑ around a face f:

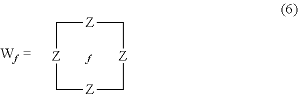

The bosonization map is:

$$\begin{matrix}{S}_{e} ⟷ {U}_{e} , \\ {P}_{f} ⟷ {W}_{f} ,\end{matrix} \qquad ( 7 )$$

or pictorially

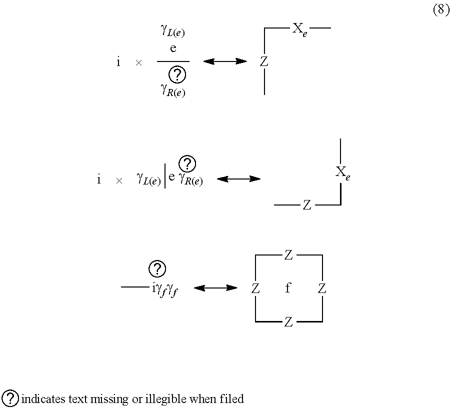

The condition PₐP_{c}S₅₈S₅₆S₂₅S₄₅=1 on fermionic operators gives a gauge (stabilizer) constraint Gᵥ=W_{fc}Π_{e⊃}_{₅}Xₑ=1 for bosonic operators, or generally

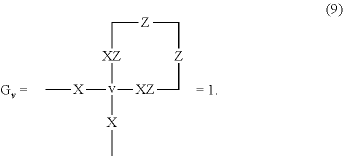

The gauge constraint Eq. (9) can be considered as the stabilizer (Gv|Ψ [symbol] =|Ψ [symbol] for |Ψ [symbol] in the code space), which forms the stabilizer group G. The operators Uₑ and W_{f} generate all logical operators. The weight of a Pauli string operator O is the number of Pauli matrices in O, denoted as wt(O). For example, we have wt(U₅₆)=wt(U₅₈)=2, wt(W_{f})=4, and wt(Gᵥ)=6. The code distance d is defined as the minimum weight of a logical operator excluding stabilizers:

$$d = min \{ wt ( O ) \vert [ O , 𝒢 ] = 0 , O ∉ 𝒢 \} . \qquad ( 10 )$$

The code distance of this original bosonization is d=2 as Uₑ has weight 2 and any single Pauli matrix violates at least one Gᵥ, which implies that there is no logical operator with weight 1.

There are four types of nearest-neighbor hopping terms (γ_{L}γ′_{R}, γ_{L}γ_{R}, γ′_{L}γ′_{R}, and γ′_{L}γ_{R}) and one type of fermion occupation term (−iγ_{f}γ′_{f}). When mapped to Pauli matrices, their weights wtᵢ are in the range 2≤wtᵢ≤6. The maximum weight corresponds to the worst case to simulate the fermion hopping term or the fermion occupation term. A good stabilizer code requires a balance between the minimum weight and the maximum weight. A high minimum weight guarantees the error-correcting property, while a low maximum weight implies that the cost of simulation is low. We label the minimum and maximum weights of the hopping terms as wtₘᵢₙ and wtₘₐₓ. In this example, (wtₘᵢₙ, wtₘₐₓ)=(2, 6).

We now introduce a new way to map the fermionic operators Sₑ and P_{f} to Pauli matrices. For simplicity, we present the mapping in a pictorial way:

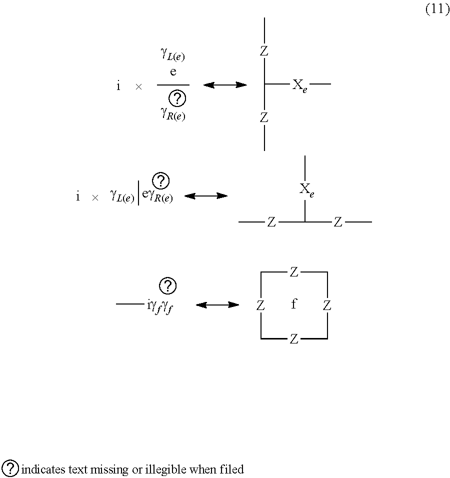

The stabilizer on the bosonic side is

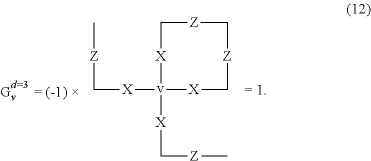

Notice that there is a minus sign coming from ZXZ=−X. We can manually check that the logical operators defined in Eq. (11) do commute with the stabilizer in Eq. (12).

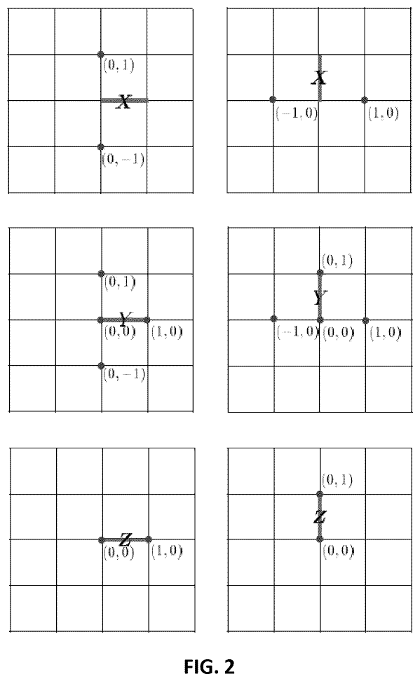

Given the stabilizer, we can provide the syndromes for all single-qubit Pauli errors, as shown in FIG. 2. We see that all single-qubit Pauli matrices have different syndromes, which means that we do not have any logical operators with weight 2. This implies a code distance of d≥3. Eq. (11) shows logical operators with weight 3, so we conclude that the code distance is d=3. Based on the syndrome measurements, we can always correct any single-qubit error according to FIG. 2.

The four types of nearest-neighbor hopping terms, γ_{L}γ′_{R}, γ_{L}γ_{R}, γ′_{L}γ′_{R}, and γ′_{L}γ_{R} have weights wtᵢ in the range 3≤wtᵢ≤5. Therefore, the modified bosonization has (wtₘᵢₙ, wtₘₐₓ)=(3, 5) and a fermionic occupation term of weight 4. Compared to the original bosonization with (wtₘᵢₙ, wtₘₐₓ)=(2, 6), the minimum weight is increased such that error correction can be performed, while the maximum weight of the hopping terms is decreased implying a reduction in the simulation cost.

Here we present the spinless Fermi-Hubbard Hamiltonian in 2d square lattice for d=3 encoding as a concrete example. The 2d spinless Fermi-Hubbard Hamiltonian is

$$H = - t \sum \text{?} ( {c}_{i}^{†} {c}_{j} + h . c . ) + U {\sum }_{〈 i , j 〉} {c}_{i}^{†} {c}_{i} {c}_{j}^{†} {c}_{j} , \qquad ( 13 )$$

$$\text{?} \text{indicates text missing or illegible when filed}$$

where [symbol] i, j [symbol] represents the nearest-neighbor pair of vertices in the square lattice. Individual terms can be written in Majorana basis as

$${c}_{i}^{†} {c}_{j} + h . c . = \frac{i}{2} ( {γ}_{i} {γ}_{j}^{′} - {γ}_{i}^{′} {γ}_{j} ) , {c}_{i}^{†} {c}_{i} {c}_{j}^{†} {c}_{j} = ( \frac{1 + i {γ}_{i} {γ}_{i}^{′}}{2} ) ( \frac{1 + i γ \text{?} {γ}_{j}^{′}}{2} ) .$$

$$\text{?} \text{indicates text missing or illegible when filed}$$

Next, we map the hopping terms and density-density interaction term to Pauli operators as follows

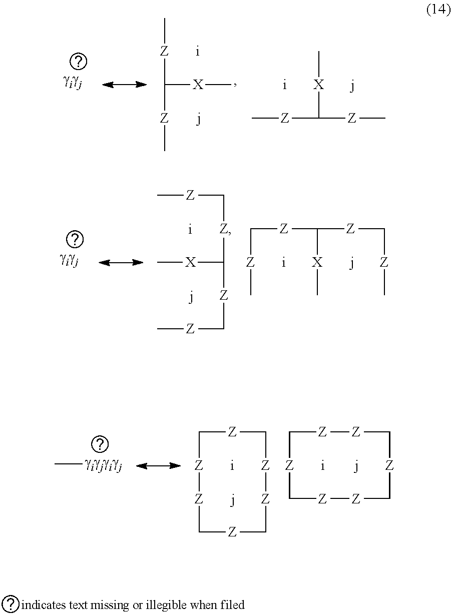

where two terms on the right-hand side correspond to the vertical and horizontal (i, j). The hopping terms have weights ranging from 3 to 5, and the interaction term has a weight 6.

Next, we provide a construction of an exact bosonization with code distance d=4 as an intermediate step toward d=5. Since its code distance is d=4, which is even, this code (like the d=3 code) can only correct the

$$⌊ \frac{d - 1}{2} ⌋ = 1$$

Pauli error. However, for error defection, Pauli errors up to weight 3 can be observed from the stabilizer syndrome measurements.

The mapping can be described as

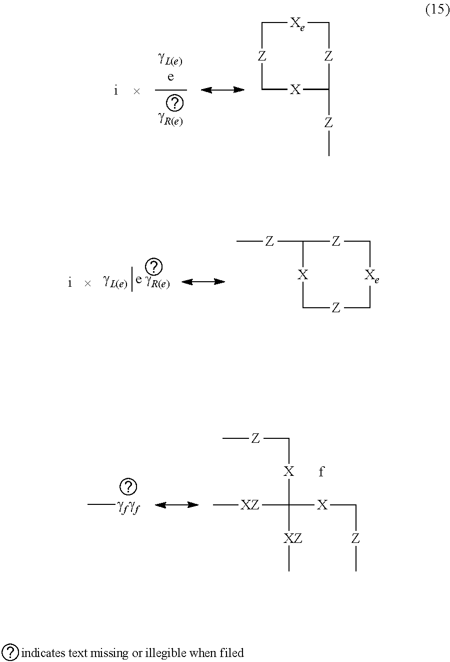

The stabilizer becomes

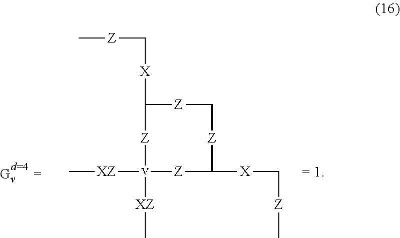

The logical operators in Eq. (15) commute with the stabilizer in Eq. (16).

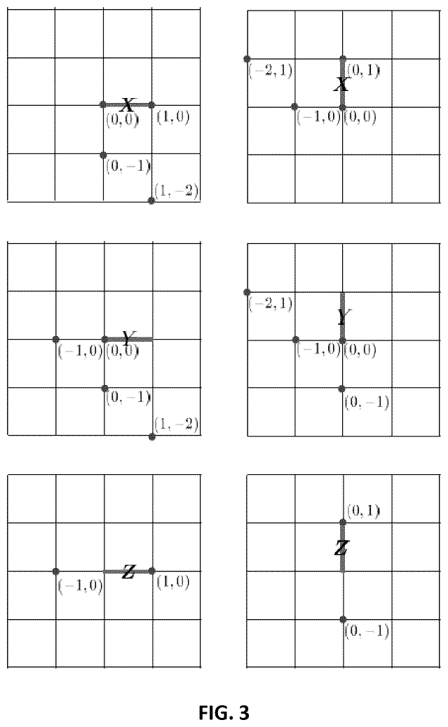

The syndromes for all single-qubit Pauli errors are provided in FIG. 3. The minimum weight is 5. However, based on the syndromes in FIG. 3, we find that the following operator is logical:

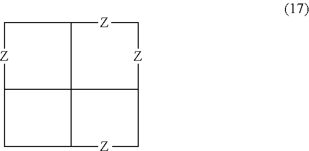

Since it does not commute with the terms in Eq. (15), this operator does not belong to the stabilizer group. Therefore, the code distance for this stabilizer code is d≤4. One can use a “syndrome matching” method to provide a lower bound for the code distance for a given stabilizer code. With such a method, it is apparent that the stabilizer code defined by Eq. (16) has a code distance of d=4.

The minimum and maximum weights of the nearest-neighbor terms are (wtₘᵢₙ, wtₘₐₓ)=(5,6) and the fermionic occupation term has weight 6, which means that all the operations are quite well-balanced. This code has an error-correcting property for any single-qubit error.

We now move to a bosonization map with code distance d=5. The generators of the even fermionic algebra are mapped to Pauli matrices as shown below:

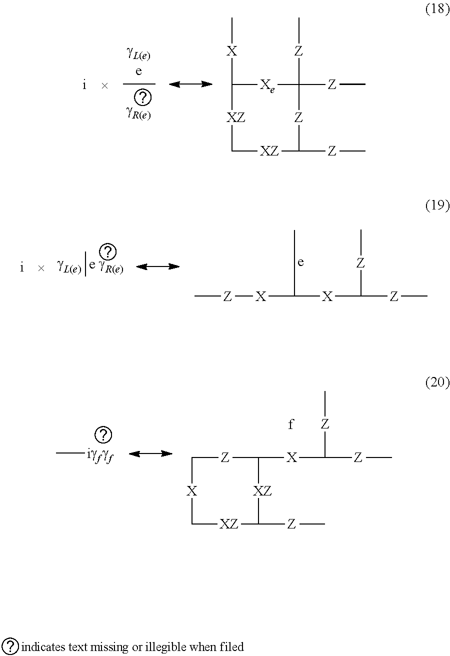

The stabilizer is

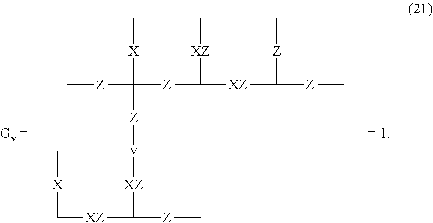

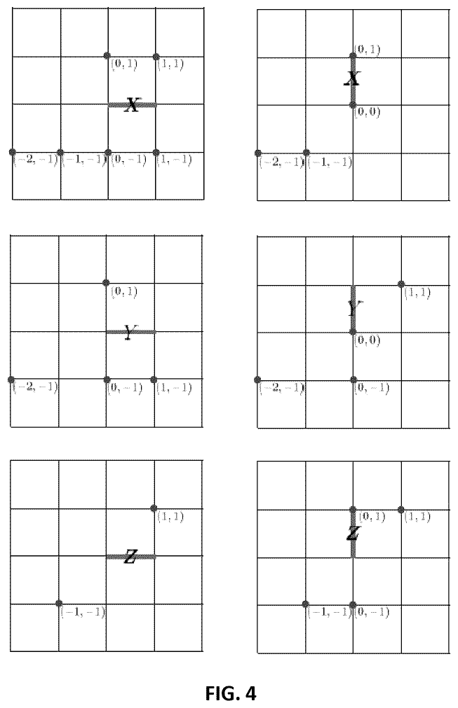

The minimum and maximum weights of the nearest-neighbor terms are (wtₘᵢₙ, wtₘₐₓ)=(5, 9) and the weight of the fermionic occupation term is 8. We use the “syndrome matching” method in Appendix A to confirm that d=5. This code has an error-correcting property for any two-qubit error. The syndromes for all single-qubit Pauli errors are provided in FIG. 4.

We turn now to a discussion of the stabilizer code formalism and the Pauli module representation via Laurent polynomials. The Laurent polynomial method is first reviewed. Then, we discuss bosonization with distance d=3, 4, 5 and the corresponding symplectic automorphisms. The searching algorithm for automorphisms is thereafter presented.

We start by reviewing how any Pauli operator can be expressed as a vector over the Laurent polynomial ring R=F₂[x, y, x⁻¹, y⁻¹]. First, we define X₁₂, Z₁₂, X₁₄, and Z₁₄ in FIG. 1 as column vectors:

$${X}_{12} = [ \begin{matrix}1 \\ 0 \\ 0 \\ 0\end{matrix} ] , \qquad ( 22 )$$

$${Z}_{12} = [ \begin{matrix}0 \\ 0 \\ 1 \\ 0\end{matrix} ] ,$$

$${X}_{14} = [ \begin{matrix}0 \\ 1 \\ 0 \\ 0\end{matrix} ] ,$$

$${Z}_{14} = [ \begin{matrix}0 \\ 0 \\ 0 \\ 1\end{matrix} ] .$$

The Pauli Y can be written as a vector which is a sum of corresponding vectors of X and Z, such as

$${Y}_{12} = [ \begin{matrix}1 \\ 0 \\ 1 \\ 0\end{matrix} ] . \qquad ( 23 )$$

We express the vector representation of the Pauli Y operator on an edge e as X Z along the same edge. It is important to note that in this representation, we quotient out the phase factor ±1, ±i associated with Pauli operators. For instance, we equate Y,−Y, iY,−iY with Y. Our primary focus is on the commutation and anti-commutation properties of Pauli operators; thus, quotienting out the phase factor ±1, ±i does not impede our calculations. In practical applications, the phase factor can be efficiently tracked, as demonstrated in the Gottesman-Knill theorem.

All the other edges can be defined with the help of translation operators as follows. We use polynomials of x and y to represent translation in the x and y directions, respectively. For example,

$${Z}_{78} = {y}^{2} [ \begin{matrix}0 \\ 0 \\ 1 \\ 0\end{matrix} ] = [ \begin{matrix}0 \\ 0 \\ {y}^{2} \\ 0\end{matrix} ] , \qquad ( 24 )$$

$${X}_{58} = xy [ \begin{matrix}0 \\ 1 \\ 0 \\ 0\end{matrix} ] = [ \begin{matrix}0 \\ xy \\ 0 \\ 0\end{matrix} ] .$$

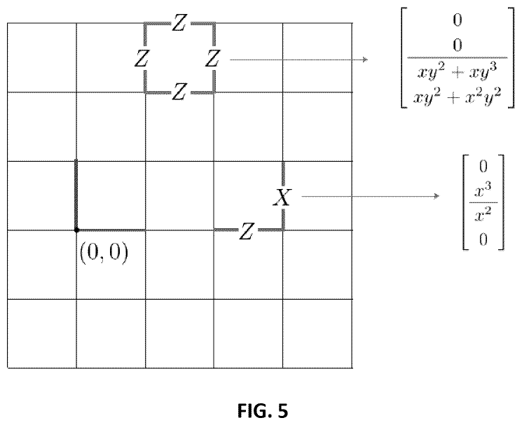

More examples are included in FIG. 5.

Next, we introduce the antipode map that is an F₂-linear map from R to R defined by

$${x}^{a} {y}^{b} \to \overline{{x}^{a} {y}^{b}} := {x}^{- a} {y}^{- b} . \qquad ( 25 )$$

To determine whether two Pauli operators represented by vectors v₁ and v₂ commute or anti-commute, we define the dot product as

$${v}_{1} \cdot {v}_{2} = {\overline{v}}_{1}^{†} Λ {v}_{2} , \qquad ( 26 )$$

where T is the transpose operation on a matrix and

$$Λ = [ \begin{matrix}0 & 0 & 1 & 0 \\ 0 & 0 & 0 & 1 \\ - 1 & 0 & 0 & 0 \\ 0 & - 1 & 0 & 0\end{matrix} ] , \qquad ( 27 )$$

is the matrix representation of the standard symplectic bilinear form. Notice that −1 is the same as 1 because we are working over the Z₂ field. For simplicity, we denote (̅ .̅ .̅ .̅ )̅^{T} as ( . . . )^{†}.

The two operators v₁ and v₂ commute if and only if the constant term of v₁·v₂ is zero. For example, we calculate the dot products

$${X}_{12} \cdot {Z}_{12} = 1 , \qquad ( 28 )$$

$${X}_{58} \cdot {Z}_{14} = {x}^{- 1} {y}^{- 1} ,$$

and, therefore, X₁₂ and Z₁₂ anti-commute, whereas X₅₈ and Z₁₄ commute (their dot product only has a non-constant term x⁻¹ y⁻¹). Furthermore, the physical meaning of X₅₈·Z₁₄=x⁻¹y⁻¹ is that the shifting of X₅₈ in −x and −y directions by 1 step will anti-commute with Z₁₄. A translationally invariant stabilizer code forms an R-submodule V such that

$$\begin{matrix}{v}_{1} \cdot {v}_{2} = {v}_{1}^{†} Λ {v}_{2} = 0 , & ∀ {v}_{1}\end{matrix} , {v}_{2} ∈ V . \qquad ( 29 )$$

We now study the automorphisms A of the symplectic form Λ:

$${\begin{matrix}( {Av}_{1} ) \cdot ( {Av}_{2} ) = {v}_{1} \cdot {v}_{2} , & ∀ v\end{matrix}}_{1} , {v}_{2} ∈ V . \qquad ( 30 )$$

This is equivalent to A^{†}ΛA=Λ. All matrices A satisfying this equation form the PGP-symplectic group. We divide A into 2×2 blocks

$$A = [ \begin{matrix}a & b \\ c & d\end{matrix} ] ,$$

the automorphism condition becomes

$$[ \begin{matrix}{a}^{†} & {c}^{†} \\ {b}^{†} & {d}^{†}\end{matrix} ] [ \begin{matrix}0 & I \\ - I & 0\end{matrix} ] [ \begin{matrix}a & b \\ c & d\end{matrix} ] = [ \begin{matrix}0 & I \\ - I & 0\end{matrix} ] \qquad ( 31 )$$

$$⇒ {a}^{†} d - {c}^{†} b = I , {a}^{†} c = {c}^{†} a , {b}^{†} d = {d}^{†} b .$$

Examples of the automorphism A are

$$S = [ \begin{matrix}I & 0 \\ c & I\end{matrix} ] , where c ∈ {Mat}_{2} [ R ] , and {c}^{†} = c , \qquad ( 32 )$$

$$S = [ \begin{matrix}0 & I \\ - I & 0\end{matrix} ] ,$$

$$C = [ \begin{matrix}1 & 0 & 0 & 0 \\ r & 1 & 0 & 0 \\ 0 & 0 & 1 & \overline{r} \\ 0 & 0 & 0 & 1\end{matrix} ] , where r ∈ R .$$

Mat₂[R] consists of all 2×2 matrices with entries in R=F₂[x, y, x⁻¹, y⁻¹]. The generators of the symplectic group are discussed below. We have selected sixteen elementary automorphisms, denoted as A₁, A₂, . . . , A₁₆, from the symplectic group. These automorphisms can be expressed by the conjugation of a unitary operator, i.e., the effect of the automorphism is

$$P {⟶}^{A} {UPU}^{†} \qquad ( 33 )$$

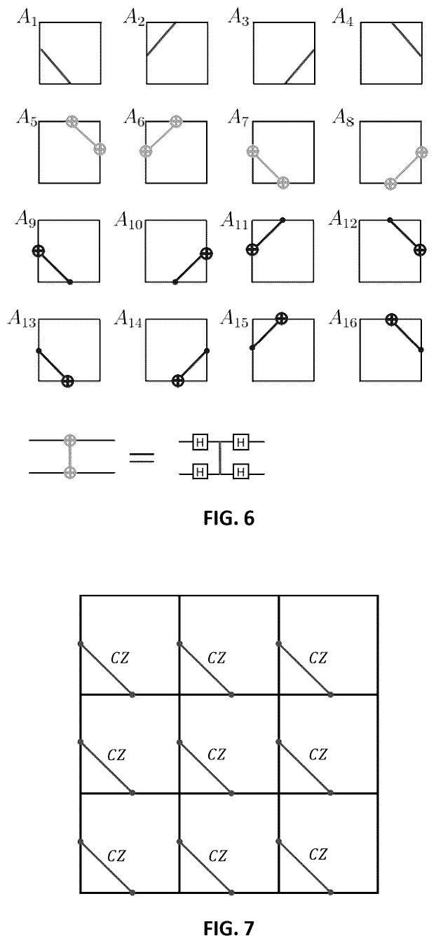

The corresponding unitary circuits for the sixteen elementary automorphisms are illustrated in FIG. 6.

New stabilizer codes have been developed from the automorphisms. First, we reformulate the original bosonization introduced above and incorporate it into the Pauil module. For simplicity, we will write x⁻¹ and y⁻¹ as x̅ and y̅, respectively. The original hopping operators Uₑ in Eq. (5) can be written as

$${U}_{1} = [ \begin{matrix}1 \\ 0 \\ 0 \\ \overline{y}\end{matrix} ] , \qquad ( 34 )$$

$${U}_{2} = [ \begin{matrix}0 \\ 1 \\ \overline{x} \\ 0\end{matrix} ] ,$$

where U₁ represents Uₑ on the horizontal edge and U₂ represents Uₑ on the vertical edge. The flux term W_{f} in (6) is written as

$$W = [ \begin{matrix}0 \\ 0 \\ 1 + y \\ 1 + x\end{matrix} ] . \qquad ( 35 )$$

The stabilizer Gᵥ in Eq. (9) corresponds to the vector

$$G = [ \begin{matrix}1 + \overline{x} \\ 1 + \overline{y} \\ 1 + y \\ 1 + x\end{matrix} ] . \qquad ( 36 )$$

Now, we will apply automorphisms on these vectors to generate new stabilizer codes.

Regarding automorphism for code distance d=3, we consider the simplest automorphism

$${A}_{1} = [ \begin{matrix}1 & 0 & 0 & 0 \\ 0 & 1 & 0 & 0 \\ 0 & 1 & 1 & 0 \\ 1 & 0 & 0 & 1\end{matrix} ] , \qquad ( 37 )$$

which modifies the Pauli operator Xₑ as

$${A}_{1} = [ \begin{matrix}1 \\ 0 \\ 0 \\ 0\end{matrix} ] = [ \begin{matrix}1 \\ 0 \\ 0 \\ 1\end{matrix} ] , \qquad ( 38 )$$

$${A}_{1} = [ \begin{matrix}0 \\ 1 \\ 0 \\ 0\end{matrix} ] = [ \begin{matrix}0 \\ 1 \\ 1 \\ 0\end{matrix} ] .$$

Pictorially, this is equivalent to

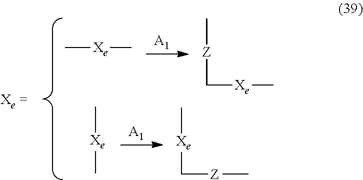

Notice that Zₑ is unchanged under this automorphism. This automorphism corresponds to the Clifford circuit shown in FIG. 7.

Now we apply A₁ on the logical operators U₁, U₂, and W and the stabilizer G:

$${A}_{1} {U}_{1} = [ \begin{matrix}1 \\ 0 \\ 0 \\ 1 + \overline{y}\end{matrix} ] , \qquad ( 40 )$$

$${A}_{1} {U}_{2} = [ \begin{matrix}0 \\ 1 \\ 1 + \overline{x} \\ 0\end{matrix} ] ,$$

$${A}_{1} W = [ \begin{matrix}0 \\ 0 \\ 1 + y \\ 1 + x\end{matrix} ] , \qquad ( 41 )$$

$${A}_{1} G = [ \begin{matrix}1 + \overline{x} \\ 1 + \overline{y} \\ y + \overline{y} \\ x + \overline{x}\end{matrix} ] .$$

The automorphism A₁ applied on Uₑ can be visualized as

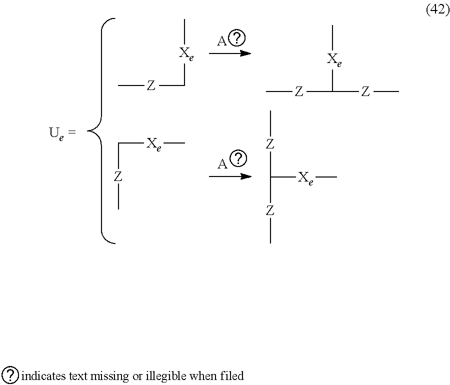

The flux term Eq. (6) is unchanged. The automorphism A₁ applied on the stabilizer Gᵥ is

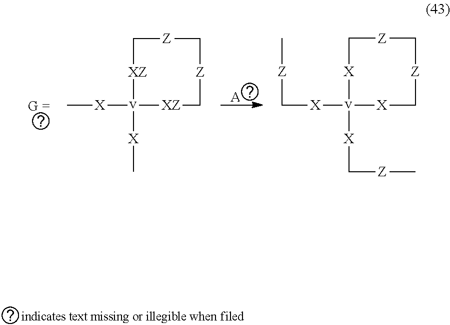

This is the bosonization with code distance d=3 introduced above. Since we applied the automorphism of the Pauli module on the original bosonization, the logical operators satisfy the same algebra. Therefore, this new stabilizer code is a valid way to simulate fermions.

Turning now to a slightly more complicated automorphism for code distance d=4, the automorphism A′ (or A₄A₇ as defined below) is:

$${A}^{′} = [ \begin{matrix}1 & 0 & 0 & 1 \\ 0 & 1 & 1 & 0 \\ 0 & \overline{x} y & 1 + \overline{x} y & 0 \\ x \overline{y} & 0 & 0 & 1 + \overline{x} y\end{matrix} ] . \qquad ( 44 )$$

A′ satisfies the condition in Eq. (31) for being an automorphism. Applying A′ on the logical operators U₁, U₂, and W and the stabilizer G, we get

$${A}^{′} {U}_{1} = [ \begin{matrix}1 + \overline{y} \\ 0 \\ 0 \\ x {\overline{y}}^{2} + x \overline{y} + \overline{y}\end{matrix} ] , \qquad ( 45 )$$

$${A}^{′} {U}_{2} = [ \begin{matrix}0 \\ 1 + \overline{x} \\ \overline{x} + \overline{x} y + {\overline{x}}^{2} y \\ 0\end{matrix} ] ,$$

$${A}^{′} W = [ \begin{matrix}1 + x \\ 1 + y \\ 1 + y + \overline{x} + \overline{x} {y}^{2} \\ 1 + x + \overline{y} + \overline{y} {x}^{2}\end{matrix} ] , \qquad ( 46 )$$

$${A}^{′} G = [ \begin{matrix}x + \overline{x} \\ y + \overline{y} \\ 1 + y + \overline{x} + \overline{x} {y}^{2} \\ 1 + x + \overline{y} + \overline{y} {x}^{2}\end{matrix} ] .$$

The operators A′(Uₑ) can be depicted as

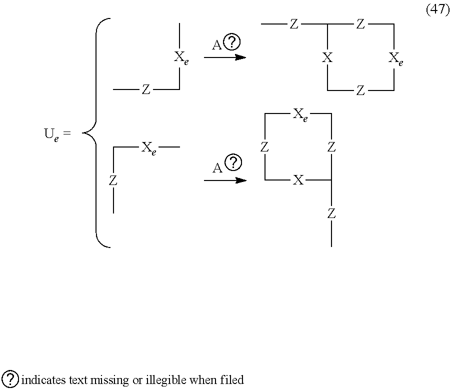

The stabilizer A′(Gᵥ) is

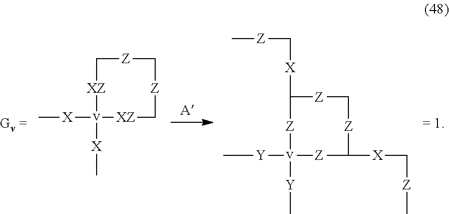

The logical operator Uₑ and the stabilizer Gᵥ are mapped on the bosonization with code distance d=4 introduced above.

Finally, the flux term under the automorphism A′ becomes

This term can be simplified by multiplying it by A′(Gᵥ), which does not change the effective logical operation. The resulting flux term is

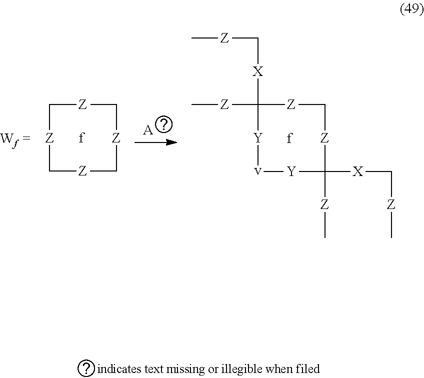

which matches Eq. (15).

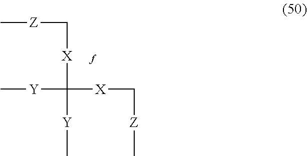

Turning now to code distance d=5, we introduce another automorphism A″ (A₉A₃A₇A₁₄ in terms of elementary automorphisms described below):

$${A}^{′′} = [ \begin{matrix}1 & \overline{x} & x & 1 \\ 1 & \overline{x} + 1 & 1 + x & 1 \\ x & \overline{x} + 1 & \overline{x} + 1 + x + {x}^{2} & 1 + x \\ x & 1 & x + {x}^{2} & 1 + x\end{matrix} ] . \qquad ( 51 )$$

It satisfies the condition in Eq. (31) for being an automorphism. Applying A″ on the logical operators U₁, U₂, and W and the stabilizer G, we get

$${A}^{′′} {U}_{1} = [ \begin{matrix}1 + \overline{y} \\ 1 + \overline{y} \\ \overline{y} + x \overline{y} + x \\ \overline{y} + x \overline{y} + x\end{matrix} ] , \qquad ( 52 )$$

$${A}^{′′} {U}_{2} = [ \begin{matrix}1 + \overline{x} \\ 0 \\ {\overline{x}}^{2} + x \\ x\end{matrix} ] ,$$

$${A}^{′′} ( W + G ) = [ \begin{matrix}\overline{xy} + 1 \\ \overline{xy} + \overline{y} \\ \overline{xy} + \overline{y} + \overline{x} + x \\ \overline{y} + x\end{matrix} ] , \qquad ( 53 )$$

$${A}^{′′} G = [ \begin{matrix}\overline{xy} + xy \\ \overline{xy} + \overline{y} + y + xy \\ \overline{xy} + \overline{y} + \overline{x} y + y + xy + {x}^{2} y \\ \overline{y} + 1 + xy + {x}^{2} y\end{matrix} ] .$$

The A″(Uₑ) operators can be depicted as Eq. (18) and (19). Here, we choose A″(W+G) as our flux operator shown in Eq. (20) because it has a lower weight wt[A″(W+G)]<wt(A″W). The pictorial representation of stabilizer A″G is Eq. (21).

We now turn to describe how one can find automorphisms with code distances d=3, 4, 5, 6, and 7. The automorphisms A₁ in Eq. (37), A′ in Eq. (44), and A″ in Eq. (51) correspond to the examples for d=3, d=4, and d=5, respectively. We will show other examples with different code distances.

First, we consider sixteen elementary automorphisms A₁, A₂, . . . , A₁₆ (shown below), which attach no more than one new Pauli matrix to the original Pauli matrix. For example, the A₁ automorphism attaches one Z to Xₑ, as shown in Eq. (38). Given the sixteen elementary automorphisms, their product Aᵢ_{₁}Aᵢ_{₂}Aᵢ_{₃}Aᵢ_{₄} . . . with iₙ∈{1, 2, . . . , 16} is also an automorphism. (We note that these elementary automorphisms do not generate all automorphisms.) We find that the product of five elementary automorphisms Aᵢ_{₁}Aᵢ_{₂}Aᵢ_{₃}Aᵢ_{₄}Aᵢ_{₅} is sufficient to generate the code distance d=7; therefore, we focus on products with five or fewer elementary automorphisms.

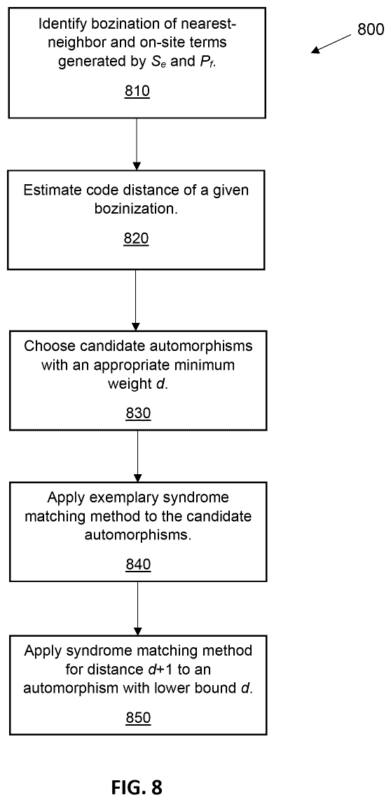

Turning now to FIG. 8, shown is an exemplary method for searching for automorphisms with large code distances at 800.

At block 810, the bosonization of all the nearest-neighbor and on-site terms generated by Sₑ and P_{f} is identified. They include the automorphism acting on U₁, U₂, W, U₁+W, U₁+y̅W, U₁+y̅W+W, U₂+W, U₂+x̅W, U₂+x̅W+W. The stabilizer G can be added to any term.

At block 820, the code distance of a given bosonization (automorphism) A is roughly estimated using the minimum weight of bosonization of nearest-neighbor hopping terms.

At block 830, some candidate automorphisms with an appropriate minimum weight dare chosen, to find a bosonization with desired code distance d.

At block 840, an exemplary syndrome matching method disclosed herebelow is applied to the candidate automorphisms. By applying syndrome matching, a lower bound of their code distances may be found.

At block 850, the syndrome matching method for distance d+1 is applied to an automorphism A with a lower bound d. If syndrome matching for distance d+1 returns a logical operator with no syndrome, conclude that Ã is a bosonization with code distance d.

Applying the syndrome-matching method, we found automorphisms to generate exact bosonization with d=3, 4, 5, 6, 7 (see Table 1). The numbers inside parentheses are the minimum and maximum weights of the logical operators for the nearest-neighbor terms. For example, A₉A₃A₇A₁₄ has the minimum logical weight 5 and the maximum logical weight 9.

TABLE 2
The possible automorphisms for different code distances.

| Code distance | Automorphisms |
|---|---|
| 3 | A₁ (3, 5) |
| 4 | A₄A₇ (5, 6), A₂A₇A₁ (4, 6) |
| 5 | A₉A₃A₇A₁₄ (5, 9) |
| 6 | A₁A₅A₁₄A₁(6, 13), A₄A₉A₁₆A₁₁(7, 17) |
| 7 | A₁A₁₁A₅A₁₄A₉(7, 23) |

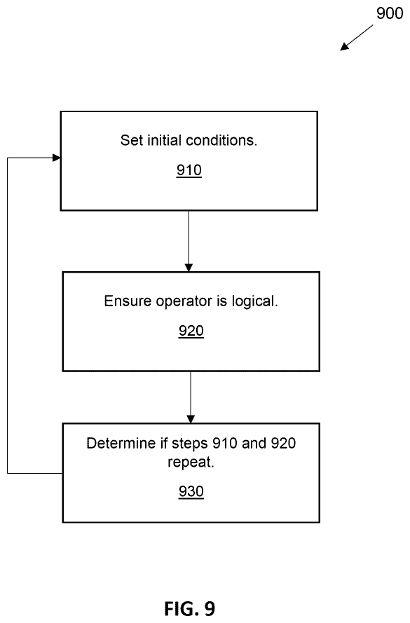

Turning now to FIG. 9 an exemplary syndrome matching method to find the code distance for a given stabilizer code is shown at 900. Specifically, given an integer n, we describe an algorithm to determine whether the code distance d satisfies d>n.

At block 910, initial conditions are set. One vertex is chosen to be the origin (0, 0). Then, a single Pauli is applied from X₁, Y₁, Z₁, X₂, Y₂, Z₂ (acting on qubits located on edges (0, 0)→(1, 0) and (0, 0)→(0, 1)). We have 6 cases, each of which has its own syndrome vertices, i.e., a set of vertices v that violate the stabilizer Gᵥ. For a single-qubit error, the syndrome set is an ordered set

$${V}^{( 1 )} = \{ ( {x}_{1}^{( 1 )} , {y}_{1}^{( 1 )} ) , ( {x}_{2}^{( 1 )} , {y}_{2}^{( 1 )} ) , ⋯ \} ,$$

ordered by

$${x}_{i}^{( 1 )} \text{:} {x}_{1}^{( 1 )} \leq {x}_{2}^{( 1 )} \leq ⋯ .$$

If two vertices i, i+1 have the same

$${x}_{i}^{( 1 )} = {x}_{i + 1}^{( 1 )} ,$$

they are ordered by

$${y}_{i}^{( 1 )} < {y}_{i + 1}^{( 1 )} .$$

At block 920 the operator is ensured to be logical. For this to be the case, all syndrome vertices should vanish. Therefore, the first syndrome vertex

$$( {x}_{1}^{( k )} , {y}_{1}^{( k )} ) ∈ {V}^{( k )}$$

is selected. Then all choices of a Pauli matrix on an edge different from the Pauli matrix selected in the previous step(s) are enumerated, such that it cancels the syndrome at

$$( {x}_{1}^{( k )} , {y}_{1}^{( k )} ) .$$

This operation may generate other syndrome vertices. The syndrome vertices V^{(k)} are updated due to this new Pauli matrix. At this stage, the operator has one more Pauli matrix, and a new ordered set for the syndrome vertices V^{(k+1)}. If the syndrome set V^{(k+1)} is empty, this operator is logical. If the operator does not belong to the stabilizer group, this means that we have found the nontrivial logical operator with the minimum weight. This minimum weight is the code distance and, therefore, the algorithm stops. Otherwise, the algorithm continues.

At block 930 it is determined whether or not blocks 910 and 920 are repeated or not. In particular, these steps repeat until the algorithm stops automatically or until all cases with operators containing n Pauli matrices have been considered, i.e., all V⁽ⁿ⁾ are checked. If the algorithm stops automatically, it will return the value of the code distance. If the algorithm stops by considering all the cases with n Pauli matrices, it concludes that code distance satisfies d>n.

We turn now to the transformation rules of Pauli matrices for sixteen elementary automorphisms used in exemplary numerical search algorithms. First, the symplectic group of vectors over the Laurent polynomial ring R=F₂[x, y, x⁻¹, y⁻¹] is generated by the following 4×4 matrices, which form the elementary symplectic group. Below a∈R^{x} is any monomial in R.

$$\begin{matrix}Hadamard : & {E}_{i , i + 2} ( − 1 ) {E}_{i + 2 , i} ( 1 ) {E}_{i , i + 2} ( − 1 ) , & where 1 \leq i \leq 2 , \\ control - Phase : & {E}_{i + 2 , j} ( a ) {E}_{j + 2 , i} ( \overline{a} ) , & where 1 \leq i , j \leq 2 , \\ control - Not : & {E}_{i , j} ( a ) {E}_{j + 2 , i + 2} ( − \overline{a} ) , & where 1 \leq i \neq j \leq 2 ,\end{matrix} \qquad ( 54 )$$

where the matrix E_{i,j}(a) for any a∈R is defined as

$${[ {E}_{i , j} ( a ) ]}_{μ v} = {δ}_{μ v} + {δ}_{μ i} {δ}_{vj} a , where δ is the Kronecker delta . \qquad ( 55 )$$

More explicitly, the Hamamard gates for i=1 and i=2 are

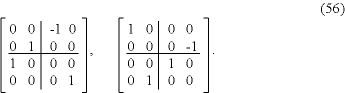

The control-Phase gates for (i, j)=(1, 1), (1, 2), (2, 1), (2, 2) are

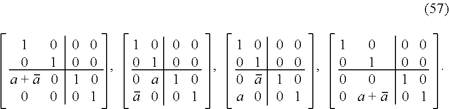

The control-Not gates for (i, j)=(1, 2), (2, 1) are

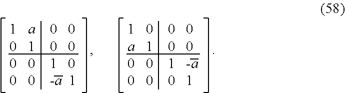

From the elementary symplectic group above, we choose the following automorphisms A₁, . . . , A₁₆, corresponding to applying nearest-neighbor two-qubit Clifford gates.

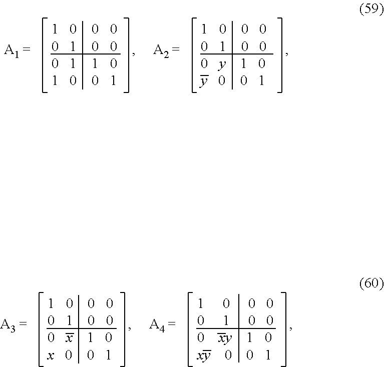

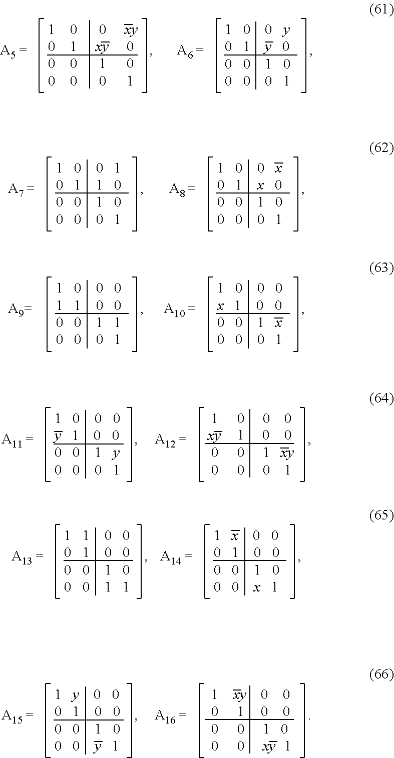

The diagonal blocks of A₁ are identities, and its nontrivial part is the lower left block which attaches an extra Z to X₁ and X₂. By multiplying the polynomial vectors of X₁, X₂, Z₁, and Z₂ by automorphism A₁, we get the following terms:

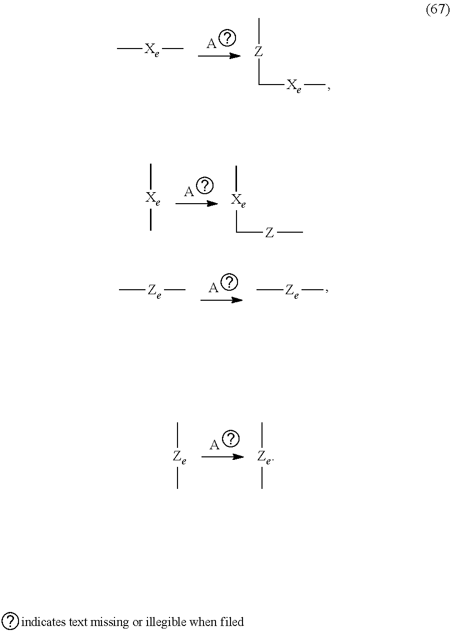

Similarly, we may multiply X, X₂, Z₁, and Z₂ by A₂, thereby obtaining

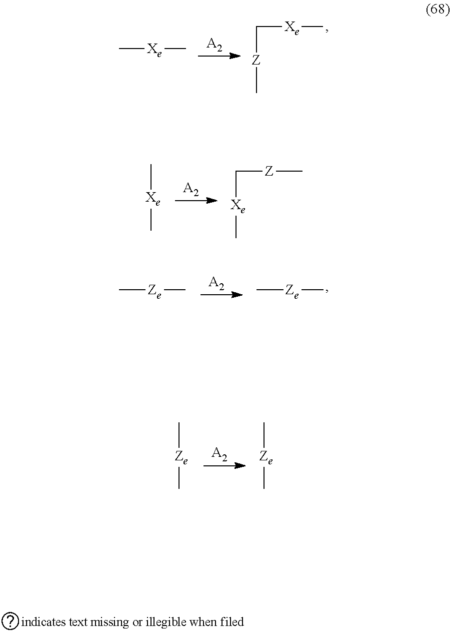

Following the same argument, we can obtain pictorial representations for the rest of the automorphisms: A₃:

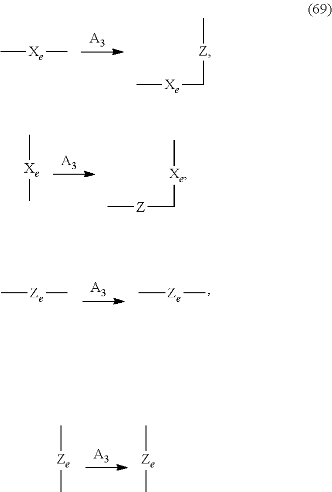

### A₄:

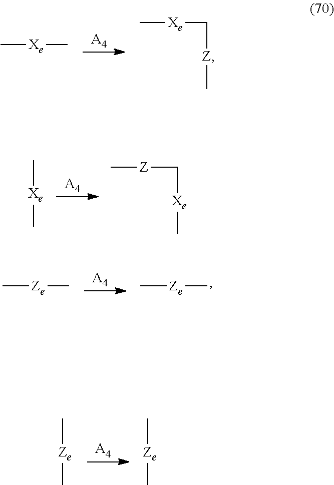

### A₅:

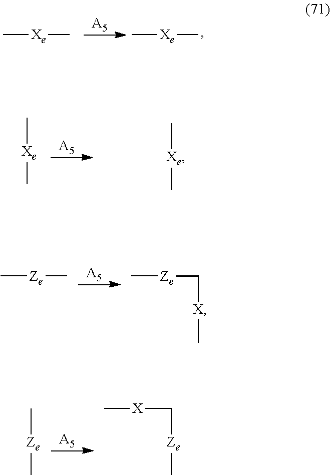

### A₆:

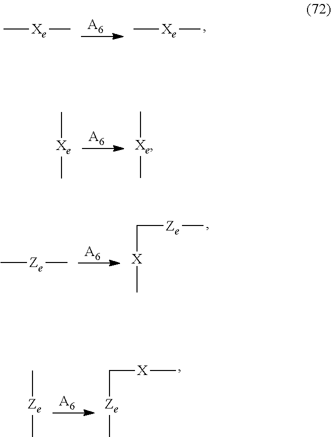

### A₇:

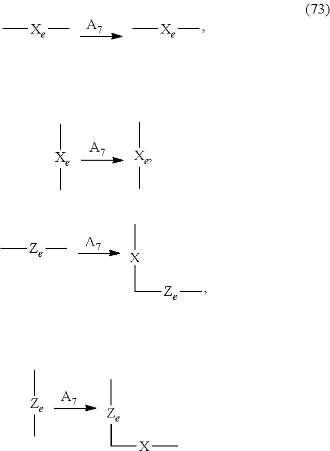

### A₈:

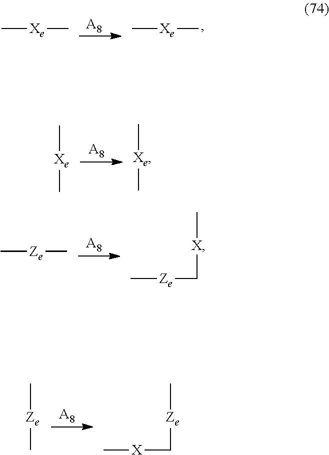

### A₉:

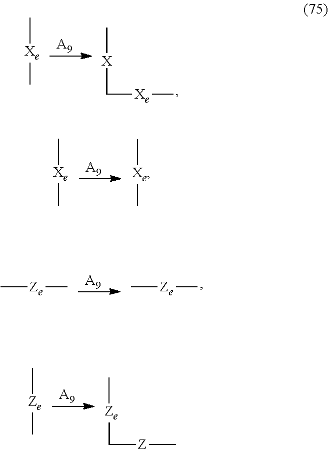

### A₁₀:

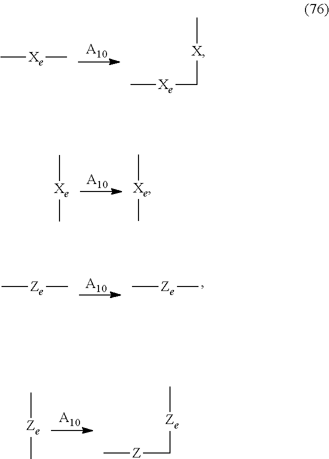

### A₁₁:

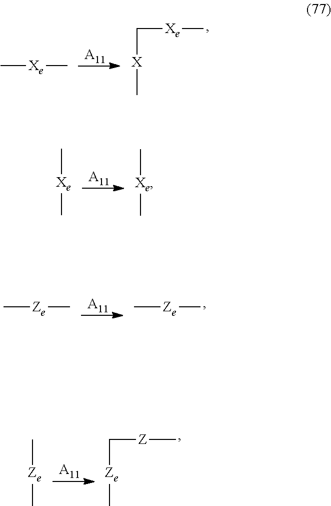

### A₁₂:

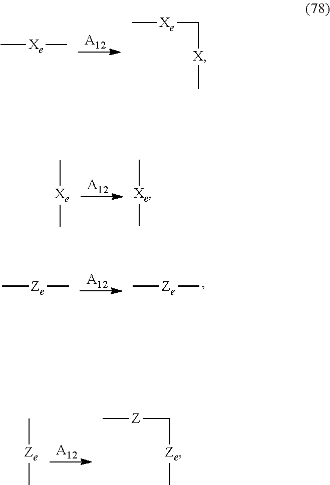

### A₁₃:

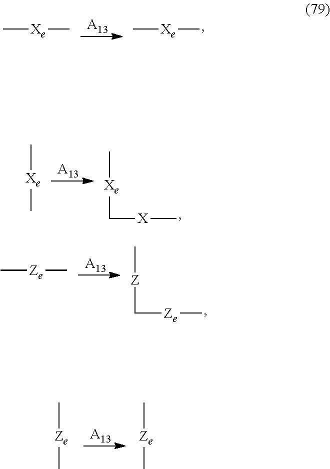

### A₁₄:

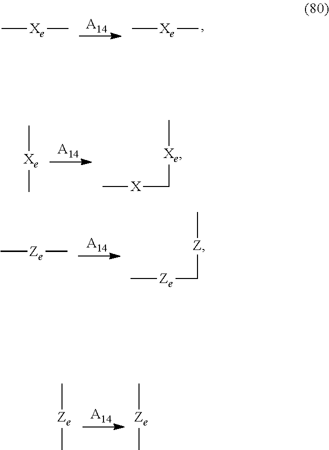

### A₁₅:

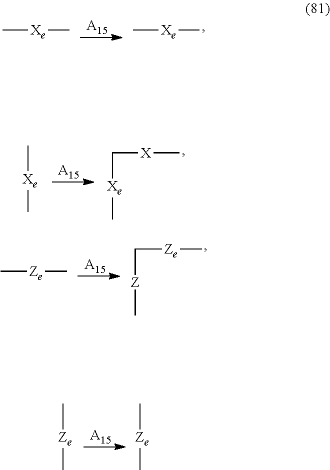

### A₁₆:

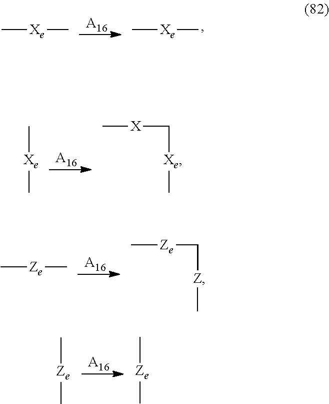

We turn now to the explicit form of automorphisms A^{d=6} and A^{d=7} found by exemplary syndrome matching. The automorphism A^{d=6}=A₁A₅A₁₄A₁ has a code distance of 6:

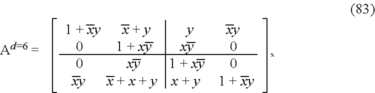

By applying A^{d=6} on logical operators U₁, U₂, W, and stabilizer G, we obtain their polynomial representations as follows:

$${A}^{d = 6} {U}_{1} = [ \frac{\begin{matrix}\overline{x} + 1 + \overline{x} y \\ 0\end{matrix}}{\begin{matrix}0 \\ \overline{y} + \overline{x} + \overline{x} y\end{matrix}} ] , \qquad ( 84 )$$

$${A}^{d = 6} {U}_{2} = [ \frac{\begin{matrix}\overline{x} + \overline{x} y + y \\ \overline{y} + x \overline{y} + 1\end{matrix}}{\begin{matrix}\overline{y} + x \overline{y} + \overline{x} \\ \overline{x} + 1 + x + \overline{x} y + y\end{matrix}} ] , \qquad ( 85 )$$

$${A}^{d = 6} W = [ \frac{\begin{matrix}\overline{x} y + {y}^{2} \\ \overline{x} \overline{y} + x\end{matrix}}{\begin{matrix}\overline{x} \overline{y} + 1 + x + y \\ 1 + \overline{x} y + x y + {y}^{2}\end{matrix}} ] , \qquad ( 86 )$$

$${A}^{d = 6} G = [ \frac{\begin{matrix}\overline{xy} + {\overline{x}}^{2} y + y + {y}^{2} \\ x {\overline{y}}^{2} + \overline{y} + 1 + x\end{matrix}}{\begin{matrix}x {\overline{y}}^{2} + 1 + x + y \\ \overline{xy} + x \overline{y} + \overline{x} + x + {\overline{x}}^{2} y + y + x y + {y}^{2}\end{matrix}} ] . \qquad ( 87 )$$

The automorphism A^{d=7}=A₁A₁₁A₅A₁₄A₉ with distance d=7 is

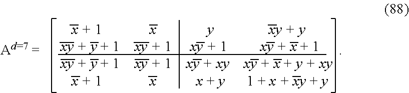

By applying A^{d=7} on logical operators U₁, U₂, W, and stabilizer G, we can write down their polynomial representations as follows:

$${A}^{d = 7} {U}_{1} = [ \begin{matrix}0 \\ \frac{{x}^{2} + 1}{x {\overline{y}}^{2} + \overline{y} + x} \\ \overline{y} + x \overline{y}\end{matrix} ] , {A}^{d = 7} {U}_{2} = [ \begin{matrix}\overline{x} + \overline{x} y \\ \frac{\overline{xy} + \overline{y} + \overline{x} + 1}{\overline{xy} + \overline{y} + 1 + y} \\ \overline{x} + 1 + \overline{x} y\end{matrix} ] , \qquad ( 89 )$$

$${A}^{d} = 7 W = [ \begin{matrix}\overline{x} y + y + xy + {y}^{2} \\ \frac{{x}^{2} \overline{y} + \overline{x} + 1 + y}{{x}^{2} \overline{y} + \overline{x} + 1 + x + y + x y + {x}^{2} y + {x}^{2} {y}^{2}} \\ 1 + x + {x}^{2} + \overline{x} y + y + {y}^{2}\end{matrix} ] , \qquad ( 90 )$$

$${A}^{d = 7} G = [ \begin{matrix}\overline{xy} + {\overline{x}}^{2} + \overline{x} + 1 + \overline{x} y + y + x y + x {y}^{2} \\ \frac{{\overline{xy}}^{2} + {\overline{x}}^{2} \overline{y} + \overline{xy} + x \overline{y} + 1 + y}{\begin{matrix}{\overline{xy}}^{2} + {\overline{x}}^{2} \overline{y} + \overline{xy} + {\overline{x}}^{2} \overline{y} \\ + 1 + x + y + x y + {x}^{2} y + x {y}^{2} \\ \overline{xy} + {\overline{x}}^{2} + \overline{x} + x + {x}^{2} + \overline{x} y + y + {y}^{2}\end{matrix}}\end{matrix} ] . \qquad ( 91 )$$

Introduced herein is a method that employs Laurent polynomials and symplectic automorphisms as efficient classical computational tools in the search for fermion-to-qubit mappings with error correction capabilities. One significant advantage of this method lies in its ability to generate equivalent mappings with higher code distances while preserving the code rates. This is possible due to the established equivalence between various 2d fermion-to-qubit mappings.

In recent years, it has been shown that Laurent polynomials do not only serve as an analytical tool to design and characterize quantum code, numerical algorithm inspired by Laurent polynomials are also proposed, for example, searching 3d fraction phases. However, beyond these conventional propositions, exemplary methods are effective in using the Laurent polynomial in searching quantum error-correcting codes. The Laurent polynomials and symplectic automorphisms serve a dual purpose in exemplary methods: They are instrumental in the analytical derivation of quantum codes and valuable for the numerical studies of these codes.

Further introduced herein are exemplary methods of using particular codes with distances d=3, 4, 5, 6, and 7. Additionally, we present exemplary methods to systematically search for and verify fermion-to-qubit mappings with elevated code distances. It is noteworthy that exemplary methods are not exclusive to fermion-to-qubit mappings; they are also applicable to regular qubit stabilizer codes, which are utilized to encode logical qubits.

In the context of implementing higher-distance error-correcting codes, which are realized through exact bosonization (with d=2) by Clifford deformations, we can prepare the codewords for these codes. This is achieved by applying the appropriate Clifford circuit to the codewords of the exact bosonization (d=2). The process involves the following steps:
1. Generating a product state in the fermionic Fock basis from the toric code ground state by exciting fermions ε=e×m. This state is a codeword of the exact bosonization (d=2).
2. Transforming this codeword using the Clifford unitary corresponding to the automorphism A.
3. The result is the codeword for the higher-distance exact bosonization, preserving the same logical information. In particular, the Clifford circuit used is geometrically local and translationally invariant, ensuring that a shallow, O(1)-depth, geometrically local Clifford circuit does not spread errors.
   This method provides a framework for developing higher-distance error-correcting codes essential for fermionic quantum simulation, simultaneously underscoring the necessity of efficient decoders for effective error correction. Given that exact bosonization originates from the toric code, the minimum weight perfect matching approach still works. Apart from quantum error correction, which includes code construction and decoder development, optimizing efficient and fault-tolerant logical operations remains a critical challenge.

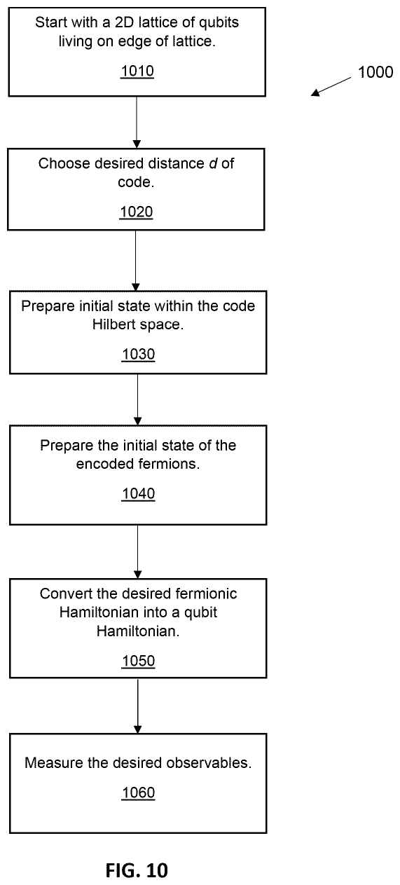

Turning now to FIG. 10, a method of encoding fermions into lattices of qubits for quantum simulation of fermionic systems in a way that automatically helps with error correction while not unduly increasing the cost of a simulation is shown at 1000.

At block 1010, the method starts with a 2D lattice of qubits living on the edges of the lattice. The qubits can be superconducting qubits, neutral-atom qubits, NV-center qubits, or the like.

At block 1020, the desired distance d of the code is chosen.

At block 1030, an initial state is prepared within the code Hilbert space by measuring stabilizers Gᵥ for each v and making corrections necessary to ensure that, after these rotations are applied, Gᵥ=1 for each v. For example, for d=2, the Hilbert space is restricted by enforcing Eq. (9) for every vertex v. For d=3, the Hilbert space restriction is done using Eq. (12). For d=4, the Hilbert space restriction is done using Eq. (16). For d=5, the Hilbert space restriction is done using Eq. (21). For d=6, the Hilbert space restriction is done using Eq. (87). For d=7, the Hilbert space restriction is done using Eq. (91).

At block 1040, the desired initial state of the encoded fermions is prepared. For example, if we want to start with fermions occupying certain specific faces of the lattice, we measure W_{f} for each face f and do appropriate corrections to make sure that, after these corrections, we have the desired initial state.

At block 1050, the desired fermionic Hamiltonian whose dynamics one is interested in simulating is converted (using a dictionary to be specified below) into a qubit Hamiltonian and then the evolution is run using either analog or digital quantum simulation. For example, for d=2, the dictionary between fermionic operators (on the left) and corresponding qubit operators (on the right) is given in Eq. (8) for every vertex v. For d=3, the dictionary is given in Eq. (11). For d=4, the dictionary is given in Eq. (15). For d=5, the dictionary is given in Eqs. (18,19,20). For d=6, the dictionary is given in Eqs. (84,85,86). For d=7, the dictionary is given in Eqs. (89,90).

Finally, at block 1060, the desired observables are measured, such as, e.g., W_{f} to see where the fermions are.

The processes described herein may be embodied in, and fully automated via, software code modules executed by a computing system that includes one or more general purpose computers or processors. The code modules may be stored in any type of non-transitory computer-readable medium or other computer storage device. Some or all the methods may alternatively be embodied in specialized computer hardware. In addition, the components referred to herein may be implemented in hardware, software, firmware, or a combination thereof.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

Any logical blocks, modules, and algorithm elements described or used in connection with the embodiments disclosed herein can be implemented as electronic hardware, computer software, or combinations of both. To clearly illustrate this interchangeability of hardware and software, various illustrative components, blocks, modules, and elements have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described or used in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, or algorithm described in connection with the embodiments disclosed herein can be embodied directly in hardware, in a software module stored in one or more memory devices and executed by one or more processors, or in a combination of the two. A software module can reside in RAM memory, flash memory, ROM memory, EPROM memory, EEPROM memory, registers, hard disk, a removable disk, a CD-ROM, or any other form of non-transitory computer-readable storage medium, media, or physical computer storage known in the art. An example storage medium can be coupled to the processor such that the processor can read information from, and write information to, the storage medium. In the alternative, the storage medium can be integral to the processor. The storage medium can be volatile or nonvolatile.

While one or more embodiments have been shown and described, modifications and substitutions may be made thereto without departing from the spirit and scope of the invention. Accordingly, it is to be understood that the present invention has been described by way of illustrations and not limitation. Embodiments herein can be used independently or can be combined.

All ranges disclosed herein are inclusive of the endpoints, and the endpoints are independently combinable with each other. The ranges are continuous and thus contain every value and subset thereof in the range. Unless otherwise stated or contextually inapplicable, all percentages, when expressing a quantity, are weight percentages. The suffix (s) as used herein is intended to include both the singular and the plural of the term that it modifies, thereby including at least one of that term (e.g., the colorant(s) includes at least one colorants). Option, optional, or optionally means that the subsequently described event or circumstance can or cannot occur, and that the description includes instances where the event occurs and instances where it does not. As used herein, combination is inclusive of blends, mixtures, alloys, reaction products, collection of elements, and the like.

As used herein, a combination thereof refers to a combination comprising at least one of the named constituents, components, compounds, or elements, optionally together with one or more of the same class of constituents, components, compounds, or elements.

All references are incorporated herein by reference.

The use of the terms “a,” “an,” and “the” and similar referents in the context of describing the invention (especially in the context of the following claims) are to be construed to cover both the singular and the plural, unless otherwise indicated herein or clearly contradicted by context. It can further be noted that the terms first, second, primary, secondary, and the like herein do not denote any order, quantity, or importance, but rather are used to distinguish one element from another. It will also be understood that, although the terms first, second, etc. are, in some instances, used herein to describe various elements, these elements should not be limited by these terms. For example, a first current could be termed a second current, and, similarly, a second current could be termed a first current, without departing from the scope of the various described embodiments. The first current and the second current are both currents, but they are not the same condition unless explicitly stated as such.

The modifier about used in connection with a quantity is inclusive of the stated value and has the meaning dictated by the context (e.g., it includes the degree of error associated with measurement of the particular quantity). The conjunction or is used to link objects of a list or alternatives and is not disjunctive; rather the elements can be used separately or can be combined together under appropriate circumstances.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A method of encoding fermions into lattices of qubits for quantum simulation of a fermionic system comprises the steps of:
choosing a desired distance d of a code;
preparing within the code Hilbert space by measuring stabilizers Gᵥ for each vertex, v, of a 2D lattice and making corrections necessary to ensure that, after rotations are applied, Gᵥ=1 for each v;
preparing a desired initial state of the encoded fermions; and
converting a Hamiltonian of the fermionic system into a qubit Hamiltonian and then running an evolution of the fermionic system.

2. The method of claim 1, wherein the step of preparing a desired initial state includes measuring W_{f} for each face f and making corrections tending to move a state of the face towards the desired initial state.

3. The method of claim 1, wherein running an evolution of the fermionic system includes using analog quantum simulation.

4. The method of claim 1, wherein running an evolution of the fermionic system includes using digital quantum simulation.

5. The method of claim 1, wherein the desired distance code d is 3, and wherein the step of preparing within the code includes restricting the Hilbert space using the equation: 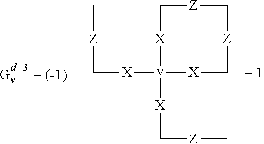
where X and Z are Pauli matrices acting on edges of the lattice.

6. The method of claim 1, wherein the desired distance code d is 3, and wherein converting a Hamiltonian of the fermionic system into a qubit Hamiltonian is governed by dictionary: 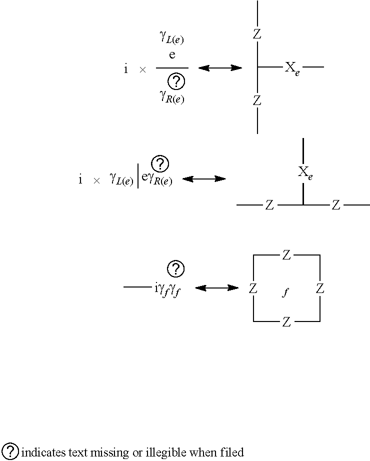
where elements associated with edges and faces are denoted by e, and f, respectively, γ_{f}, γ′_{f} represent a pair of Majorana fermions, L(e) and R(e) are faces to the left and right of edge, e, and X and Z are Pauli matrices acting on edges of the lattice.

7. The method of claim 1, wherein the desired distance code d is 4, and wherein the step of preparing within the code includes restricting the Hilbert space using the equation: 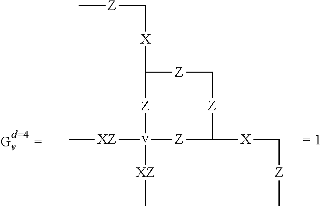
where X and Z are Pauli matrices acting on edges of the lattice.

8. The method of claim 1, wherein the desired distance code d is 4, and wherein converting a Hamiltonian of the fermionic system into a qubit Hamiltonian is governed by dictionary: 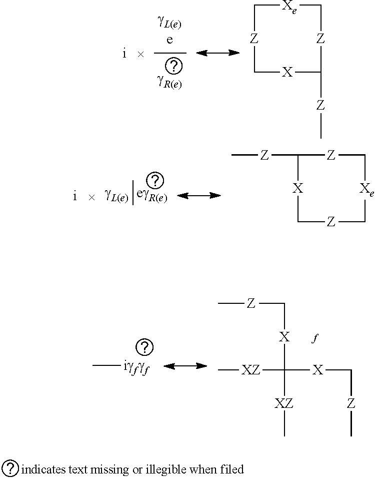
where elements associated with edges and faces are denoted by e, and f, respectively, γ_{f}, γ′_{f} represent a pair of Majorana fermions, L(e) and R(e) are faces to the left and right of edge, e, and X and Z are Pauli matrices acting on edges of the lattice.

9. The method of claim 1, wherein the desired distance code d is 5, and wherein the step of preparing within the code includes restricting the Hilbert space using the equation: 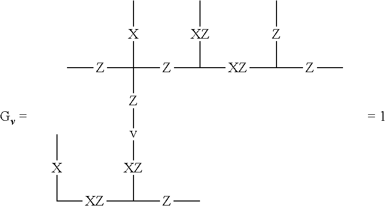
Where X and Z are Pauli matrices acting on edges of the lattice.

10. The method of claim 1, wherein the desired distance code d is 5, and wherein converting a Hamiltonian of the fermionic system into a qubit Hamiltonian is governed by dictionary: 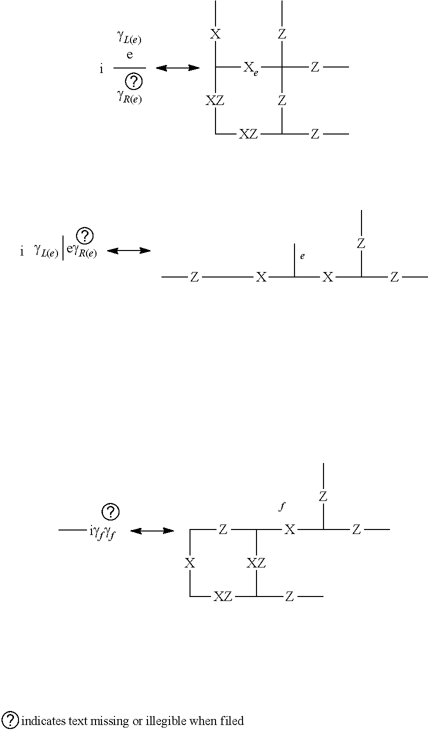
where elements associated with edges and faces are denoted by e, and f, respectively, γ_{f}, γ′_{f} represent a pair of Majorana fermions, L(e) and R(e) are faces to the left and right of edge, e, and X and Z are Pauli matrices acting on edges of the lattice.

11. The method of claim 1, wherein the desired distance code d is 6, and wherein the step of preparing within the code includes restricting the Hilbert space using the equation:
$${A}^{d = 6} G = [ \frac{\begin{matrix}\overline{xy} + {\overline{x}}^{2} y + y + {y}^{2} \\ x {\overline{y}}^{2} + \overline{y} + 1 + x\end{matrix}}{\begin{matrix}x {\overline{y}}^{2} + 1 + x + y \\ \overline{xy} + x \overline{y} + \overline{x} + x + {\overline{x}}^{2} y + y + x y + {y}^{2}\end{matrix}} ]$$
where the automorphism A^{d=6} is applied to the stabilizer G and x and y are translations in orthogonal directions.

12. The method of claim 1, wherein the desired distance code d is 6, and wherein converting a Hamiltonian of the fermionic system into a qubit Hamiltonian is done via the dictionary:
$$i \frac{\begin{matrix}{γ}_{L ( e )} \\ e\end{matrix}}{{γ}_{R ( e )}^{′}} ⟷ {A}^{d = 6} {U}_{1} = [ \frac{\begin{matrix}\overline{x} + 1 + \overline{x} y \\ 0\end{matrix}}{\begin{matrix}0 \\ \overline{y} + \overline{x} + \overline{x} y\end{matrix}} ] ,$$
$$i \times {γ}_{L ( e )} \vert e {γ}_{R ( e )} ⟷ {A}^{d = 6} {U}_{2} = [ \frac{\begin{matrix}\overline{x} + \overline{x} y + y \\ \overline{y} + x \overline{y} + 1\end{matrix}}{\begin{matrix}\overline{y} + x \overline{y} + \overline{x} \\ \overline{x} + 1 + x + \overline{x} y + y\end{matrix}} ] ,$$
$$- i {γ}_{f} {γ}_{f}^{′} ⟷ {A}^{d = 6} W = [ \frac{\begin{matrix}\overline{x} y + {y}^{2} \\ x \overline{y} + x\end{matrix}}{\begin{matrix}x \overline{y} + 1 + x + y \\ 1 + \overline{x} y + xy + {y}^{2}\end{matrix}} ] ,$$
where elements associated with edges and faces are denoted by e, and f, respectively, γ_{f}, γ′_{f} represent a pair of Majorana fermions, L(e) and R(e) are faces to the left and right of edge, e, and x and y are translations in orthogonal directions.

13. The method of claim 1, wherein the desired distance code d is 7, and wherein the step of preparing within the code includes restricting the Hilbert space using the equation:
$${A}^{d = 7} G = [ \frac{\begin{matrix}\overline{xy} + {\overline{x}}^{2} + \overline{x} + 1 + \overline{x} y + y + x y + x {y}^{2} \\ {\overline{xy}}^{2} + {\overline{x}}^{2} \overline{y} + {x y}^{―} + x y + 1 + y\end{matrix}}{\begin{matrix}\overline{xy} + {\overline{x}}^{2} \overline{y} + \overline{xy} + {x}^{2} \overline{y} \\ + 1 + x + y + x y + {x}^{2} y + x {y}^{2} \\ \overline{xy} + {\overline{x}}^{2} + \overline{x} + x + {x}^{2} + \overline{x} y + y + {y}^{2}\end{matrix}} ]$$
Where the automorphism A^{d=7} is applied to the stabilizer G and x and y are translations in orthogonal directions.

14. The method of claim 1, wherein the desired distance code d is 7, and wherein converting a Hamiltonian of the fermionic system into a qubit Hamiltonian is done via the dictionary:
$$i \frac{\begin{matrix}{γ}_{L ( e )} \\ e\end{matrix}}{{γ}_{R ( e )}^{′}} ⟷ {A}^{d = 7} {U}_{1} = [ \frac{\begin{matrix}0 \\ x {\overline{y}}^{2} + 1\end{matrix}}{\begin{matrix}x {\overline{y}}^{2} + \overline{y} + x \\ y + \overline{x} y\end{matrix}} ] ,$$
$$i \times {γ}_{L ( e )} \vert e {γ}_{R ( e )} ⟷ {A}^{d = 7} {U}_{2} = [ \frac{\begin{matrix}\overline{x} + \overline{x} y \\ \overline{xy} + \overline{y} + \overline{x} + 1\end{matrix}}{\begin{matrix}\overline{xy} + \overline{y} + 1 + y \\ \overline{x} + 1 + \overline{x} y\end{matrix}} ] ,$$
$$- i {γ}_{f} {γ}_{f}^{′} ⟷ {A}^{d = 7} W = [ \frac{\begin{matrix}\overline{x} y + y + xy + {y}^{2} \\ {x}^{2} \overline{y} + \overline{x} + 1 + y\end{matrix}}{\begin{matrix}{x}^{2} \overline{y} + \overline{x} + 1 + x + y + xy + {x}^{2} y + {xy}^{2} \\ 1 + x + {x}^{2} + \overline{x} y + y + {y}^{2}\end{matrix}} ] ,$$
where elements associated with edges and faces are denoted by e, and f, respectively, γ_{f}, γ′_{f} represent a pair of Majorana fermions, L(e) and R(e) are faces to the left and right of edge, e, and x and y are translations in orthogonal directions.

15. The method of claim 1, further comprising the step of measuring desired observables after the evolution is run.
